(19) United States
(12) Patent Application Publication
(10) Pub. No.: US 2026/0037036 A1
(43) Pub. Date: Feb. 5, 2026

(54) SLIDABLE AND ROLLABLE DISPLAY PANEL AND ELECTRONIC DEVICE

(71) Applicant: BOE TECHNOLOGY GROUP CO., LTD., Beijing (CN)

(72) Inventors: Xinqi Lin, Beijing (CN); Hong Zhu, Beijing (CN)

(73) Assignee: BOE Technology Group Co., Ltd., Beijing (CN)

(21) Appl. No.: 18/994,459

(22) PCT Filed: May 17, 2024
(86) PCT No.: PCT/CN2024/093814

§ 371 Date: Jan. 14, 2025

(30) Foreign Application Priority Data
May 25, 2023 (CN) 202310603623.7

(51) Int. Cl. G06F 1/16

(52) U.S. Cl. CPC G06F 1/1652; G06F 1/1624; G06F 1/1656

(57) ABSTRACT

A slidable and rollable display panel and an electronic device are provided. The display panel includes a planar area and a slidable and rollable area. The display panel at least includes a protective cover plate, an optical adhesive layer, a polarizer, a touch function layer, a display function layer, a back film and a support layer; the support layer at least includes a first adhesive layer, a patterned film layer, a second adhesive layer and a support member which are sequentially disposed from top to bottom; a first area of the patterned film layer corresponding to the slidable and rollable area is provided with a plurality of first mesh rows which are extended in a first direction and disposed parallel to each other in a second direction.

### CROSS REFERENCE OF RELATED APPLICATION

The present disclosure claims the priority of Chinese patent application No. 202310603623.7 filed in China on May 25, 2023, which is incorporated herein by reference in its entirety.

### TECHNICAL FIELD

The present disclosure relates to the field of display technologies, and in particular, to a slidable and rollable display panel and an electronic device.

### BACKGROUND

With the rapid development of the display industry, many panel manufacturers have introduced a slidable and rollable screen form, which allows a product to be freely converted between a mobile phone and a tablet, and the display of the screen is crease-free. In addition to showing the development of the flexibility of an upper layer material, the realization of the slidable and rollable function also shows that a support member of a lower layer is also very important, which not only provides the flexibility of free movement for a slidable and rollable area, but also provides the supportability for a non-slidable and rollable area. During the practical application, in order to meet the requirement of weight reduction in the aspect of sliding and rolling, the material optimization of the slidable and rollable area is required, for example, the traditional metal material is replaced with a lighter material such as titanium alloy, carbon fiber or the like. Meanwhile, a pattern optimized design is required. In addition, in the prior art, during a defoaming operation of a display module, since meshes in a patterned film layer have a small internal pressure, adhesive layers on both sides thereof are compressed to the meshes, thus resulting in module imprints and affecting the yield of a display panel.

### SUMMARY

The embodiments of the present disclosure aim to provide a slidable and rollable display panel and an electronic device, which are used to solve the problem of module imprints of a display module after defoaming in the prior art.

The embodiments of the present disclosure adopt the following technical solution: a slidable and rollable display panel, comprising a planar area and a slidable and rollable area, the display panel comprising a protective cover plate, and a surface on a side of the protective cover plate being provided with an optical adhesive layer, a polarizer, a touch function layer, a display function layer, a back film and a support layer which are sequentially disposed in a direction opposite to a light-emitting direction of the display panel; and the support layer at least comprising a first adhesive layer, a patterned film layer, a second adhesive layer and a support member which are sequentially disposed from top to bottom; wherein a first area of the patterned film layer corresponding to the slidable and rollable area is provided with a plurality of first mesh rows which are extended in a first direction and disposed in parallel in a second direction, and each of the first mesh rows comprises at least one first mesh extended in the first direction, which is perpendicular to the second direction in a first plane, the first direction being an extension direction of a boundary line between the planar area and the slidable and rollable area, and the first plane being a plane where the planar area is located; and a third area of the second adhesive layer corresponding to the slidable and rollable area is provided with a plurality of first through holes, and there is an overlap area between an orthographic projection of each of the first meshes on the first plane and an orthographic projection of any one of the first through holes in the third area on the first plane.

In some embodiments, a length A of the first mesh is between 0.1 mm and 50 mm; and a spacing B between adjacent two of the first meshes in the same first mesh row is between 0.1 mm and 1 mm.

In some embodiments, a rib width c between adjacent two of the first mesh rows is between 0.1 mm and 3 mm; and a width D of the first mesh is between 0.05 mm and 1 mm.

In some embodiments, the first through hole is a strip-shaped through hole extended in a third direction, an included angle between the third direction and the second direction in the first plane is between 0 degree and 180 degrees, and a projection length of the first through hole in the second direction is greater than or equal to a sum of C and D and less than or equal to a width of the slidable and rollable area in the second direction.

In some embodiments, in a case where the included angle is 0 degree or 180 degrees, the plurality of first through holes are extended in the second direction and disposed in parallel in the first direction, a length of the first through hole is greater than or equal to the width of the slidable and rollable area in the second direction, a width of the first through hole is between 0.1 and A/2, and a spacing between adjacent two of the first through holes in the first direction is greater than or equal to 0.5 mm and less than or equal to a sum of A and B.

In some embodiments, a second area of the patterned film layer corresponding to the planar area comprises a transition area that is adjacent to the first area and provided with a plurality of second mesh rows, which are extended in the first direction and disposed in parallel in the second direction, each of the second mesh rows comprises at least one second mesh extended in the first direction, lengths of the second meshes in different rows decrease uniformly in turn in a direction away from the first area, and a length of the second mesh in the second mesh row farthest from the first area is between 10% and 100% of the length A of the first mesh.

In some embodiments, a fourth area of the second adhesive layer corresponding to the transition area is provided with a plurality of second through holes, and there is an overlap area between an orthographic projection of each of the second meshes on the first plane and an orthographic projection of any one of the second through holes in the fourth area on the first plane, or, there is an overlap area between orthographic projections of a part of the second meshes on the first plane and an orthographic projection of any one of the first through holes on the first plane, and there is an overlap area between orthographic projections of the other part of the second meshes on the first plane and an orthographic projection of any one of the second through holes on the first plane.

In some embodiments, an extension direction of the second through hole is the same as that of the first through hole, the plurality of the second through holes are disposed in parallel in the first direction, and a sum of a length of the second through hole and the length of the first through hole is equal to the width of the slidable and rollable area and the transition area in the second direction, a width of the second through hole is between 0.1 and A/2, and a spacing between adjacent two of the second through holes in the first direction is greater than or equal to 0.5 mm and less than or equal to 1/2 of the sum of A and B.

In some embodiments, an area of the support member corresponding to the planar area is provided with a planar support plate, and an area of the support member corresponding to the slidable and rollable area is provided with a plurality of strip-shaped support members, which are extended in the first direction and disposed in parallel in the second direction, a width L1 of the strip-shaped support member in the second direction is between 0.3 mm and 3 mm, a spacing L2 between the adjacent strip-shaped support members in the second direction is between 0.3 mm and 3 mm, and a thickness of the strip-shaped support member is the same as that of the planar support plate; in a case where the included angle is 90 degrees, the plurality of first through holes are extended in the first direction and disposed in parallel in the second direction, a length of the first through hole is greater than a difference between a width of the patterned film layer in the first direction and A, a width of the first through hole is greater than or equal to L2/2 and less than or equal to L2, and a spacing between adjacent two of the first through holes in the second direction is greater than or equal to L1 and less than or equal to a sum of L1 and L2.

In some embodiments, the first through holes are disposed corresponding to the first meshes, and an orthographic projection of each of the first through holes on the first plane is within an orthographic projection of the corresponding first mesh on the first plane; a width of the first through hole in the first direction is greater than or equal to 0.1 mm and less than or equal to A, and a spacing between adjacent two of the first through holes in the first direction is greater than or equal to 0.5 mm and less than or equal to a sum of A and B; a width of the first through hole in the second direction is greater than or equal to 0.1 mm and less than or equal to D, and a spacing between adjacent two of the first through holes in the second direction is less than twice a sum of C and D.

In some embodiments, the first adhesive layer comprises a first sub-adhesive layer, a first base material layer and a second sub-adhesive layer which are sequentially disposed from top to bottom, and a thickness of the second sub-adhesive layer is between 25 microns and 100 microns.

The embodiments of the present disclosure further provide an electronic device, at least comprising the aforementioned slidable and rollable display panel.

The embodiments of the present disclosure have the advantageous effects that by disposing the first through holes in the second adhesive layer, each of the first meshes in the patterned film layer can be open through one of the first through holes, so that the internal and external pressures of the first mesh can be consistent during defoaming, thus avoiding the deformation of the adhesive layers on both sides thereof (especially the first adhesive layer) towards the mesh, and the problem of module imprints will not be caused.

### BRIEF DESCRIPTION OF THE DRAWINGS

In order to more clearly explain the technical solutions in the embodiments of the present disclosure or in the prior art, the drawings needed to be used in the description of the embodiments or the prior art will be briefly introduced below. Obviously, the drawings involved in the following description illustrate only some embodiments of the present disclosure, and other drawings can be obtained from these drawings by persons of ordinary skill in the art without paying any creative effort.

FIG. 1 illustrates a schematic view of a hierarchical structure of a slidable and rollable display panel according to a first embodiment of the present disclosure;

FIG. 2 illustrates a schematic view of a hierarchical structure of a first adhesive layer according to a first embodiment of the present disclosure;

FIG. 3 illustrates a top view of a patterned film layer according to a first embodiment of the present disclosure;

FIG. 4 illustrates an enlarged view of a a dashed box in FIG. 3;

FIG. 5 illustrates a top view of a support member according to a first embodiment of the present disclosure;

FIG. 6 illustrates a schematic view of a hierarchical structure of a second adhesive layer according to a first embodiment of the present disclosure;

FIG. 7 illustrates a first design mode of first through holes according to a first embodiment of the present disclosure;

FIG. 8 illustrates a second design mode of first through holes according to a first embodiment of the present disclosure;

FIG. 9 illustrates a design mode of second through holes according to a first embodiment of the present disclosure;

FIG. 10 illustrates a schematic view showing the arrangement of a first through hole and a second through hole according to a first embodiment of the present disclosure;

FIG. 11 illustrates a third design mode of first through holes according to a first embodiment of the present disclosure;

FIG. 12 illustrates an enlarged view of a dotted box in FIG. 11; and

FIG. 13 illustrates a fourth design mode of first through holes according to a first embodiment of the present disclosure.

### DETAILED DESCRIPTION

Various aspects and features of the present disclosure are described herein with reference to the drawings.

To be understood, various modifications can be made to the embodiments herein. Therefore, the above specification should not be regarded as limitations, but only as illustrations of the embodiments. Other modifications within the scope and the spirit of the present disclosure will be conceivable to persons skilled in the art.

The drawings, which are included in and constitute a part of the specification, illustrate the embodiments of the present disclosure, and together with the general description of the present disclosure given above and the detailed description of the embodiments given below, serve to explain the principle of the present disclosure.

These and other features of the present disclosure will become apparent from the following description of the preferred forms of the embodiments given as non-limiting examples with reference to the drawings.

To be further understood, although the present disclosure has been described with reference to some specific examples, persons skilled in the art can definitely realize many other equivalent forms of the present disclosure, which have the features as claimed and therefore all fall within the protection scope defined herein.

The above and other aspects, features and advantages of the present disclosure will become more apparent in view of the following detailed description when taken in conjunction with the drawings.

Hereinafter, the specific embodiments of the present disclosure will be described with reference to the drawings; However, it should be understood that the applied embodiments are only examples of the present disclosure, and may be implemented in various ways. Well-known and/or repetitive functions and structures are not described in detail, so as to avoid the present disclosure from being obscured by unnecessary or redundant details. Therefore, the specific structural and functional details applied herein are not intended to be limiting, but only as the basis of the claims and the representative basis for teaching persons skilled in the art to variously use the present disclosure in substantively any suitable detailed structure.

The specification can use a phrase “in an embodiment”, “in another embodiment”, “in still another embodiment” or “in other embodiments”, each referring to one or more of the same or different embodiments according to the present disclosure.

With the rapid development of the display industry, many panel manufacturers have introduced a slidable and rollable screen form, which allows a product to be freely converted between a mobile phone and a tablet, and the display of the screen is crease-free. In addition to showing the development of the flexibility of an upper layer material, the realization of the slidable and rollable function also shows that a support member of a lower layer is also very important, which not only provides the flexibility of free movement for a slidable and rollable area, but also provides the supportability for a non-slidable and rollable area. During the practical application, in order to meet the requirement of weight reduction in the aspect of sliding and rolling, the material optimization of the slidable and rollable area is required, for example, the traditional metal material is replaced with a lighter material such as titanium alloy, carbon fiber or the like. Meanwhile, a pattern optimized design is required. In addition, in the prior art, during a defoaming operation of a display module, since meshes in a patterned film layer have a small internal pressure, adhesive layers on both sides thereof are compressed to the meshes, resulting in module imprints and affecting the yield of a display panel.

In order to solve the above problem, a first embodiment of the present disclosure provides a slidable and rollable display panel, and a conventional hierarchical structure thereof is shown in FIG. 1, which mainly includes a protective cover plate 100, an optical adhesive layer 200, a polarizer 300, a touch function layer and a display function layer 400, a back film 500 and a support layer 600, which are sequentially disposed in a direction opposite to a light-emitting direction of the display panel. In FIG. 1, an upper part is a light-emitting side of the display panel, and a lower part is a backlight side. According to the modular structure of the display panel, the display panel may be divided into a slidable and rollable area and a planar area, wherein the planar area is a conventional display area of the display panel, the slidable and rollable area corresponds to a flexible portion, the display area of the display panel may be increased or decreased by means of bending, stretching, etc. In correspondence with the structure of the display panel shown in FIG. 1, the display panel in the slidable and rollable area may be bent downward to decrease the display area, and may be stretched to the state of FIG. 1 to increase the display area. To be noted, this embodiment defines an extension direction of an axis around which the display panel is bent as a first direction X, i.e., an extension direction of a boundary line between the slidable and rollable area and the planar area, and defines a direction perpendicular to the first direction X in a first plane as a second direction Y, wherein the first plane is a plane where the planar area is located, and a horizontal direction in FIG. 1 is the second direction Y.

In this embodiment, the protective cover plate 100 protects the modules of the remaining hierarchies and improve the mechanical performance; the optical adhesive layer 200 is mainly an Optically Clear Adhesive (OCA) to bond an upper layer and a lower layer; the back film 500 is usually a black film to protect the touch function layer and the display function layer 400; and the support layer 600 serves as a lower support member for the touch function layer and the display function layer 400. In order to ensure not only a flexible bending of the slidable and rollable area, but also a strong support to an upper hierarchy in a stretched state, as can be seen from the hierarchical structure shown in FIG. 1, the support layer 600 at least includes a first adhesive layer 610, a patterned film layer 620, a second adhesive layer 630 and a support member, which are sequentially disposed from top to bottom.

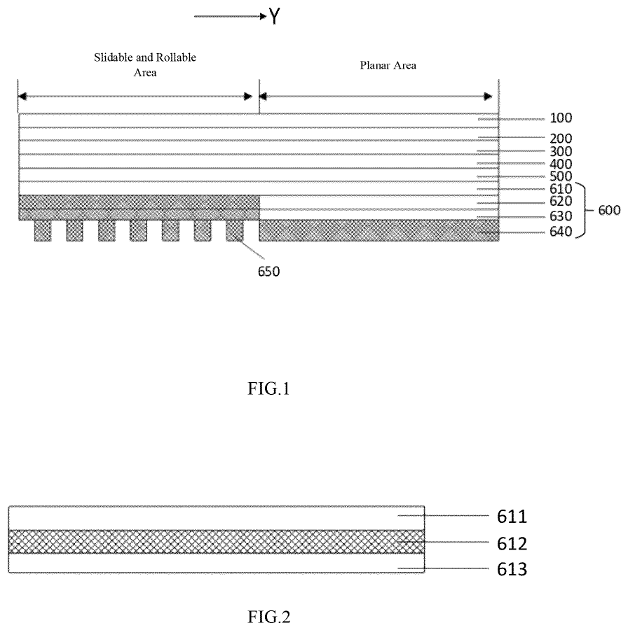

Specifically, the first adhesive layer 610 is a double-sided adhesive layer having an overall film thickness between 50 microns and 200 microns, and a hierarchical structure thereof is shown in FIG. 2, mainly including a first sub-adhesive layer 611, a first base material layer 612 and a second sub-adhesive layer 613, which are sequentially disposed from top to bottom, wherein an upper layer and a lower layer are bonded through the sub-adhesive layers on both sides of the first base material layer 612, i.e., the first sub-adhesive layer 611 is bonded to the back film 500 located above, and the second sub-adhesive layer 611 is bonded to the patterned film layer 620 located below while shielding a mesh structure of the patterned film layer 620 located below.

The first base material layer 612 may be made of a material such as Polyethylene Terephthalate (PET) or Polyurethane (PU), with a color of black to achieve a shielding effect, and a thickness between 3 microns and 70 microns; the first sub-adhesive layer 611 and the second sub-adhesive layer 613 may be made of an adhesive material such as an acrylic (polymethyl methacrylate) adhesive tape or PU glue, and both have a thicknesses between 25 microns and 100 microns. The thickness of the second sub-adhesive layer 613 defined in this embodiment is larger than the thickness of the second sub-adhesive layer 613 in the prior art. During defoaming, even though a certain thickness of adhesive material is embedded into the mesh structure of the patterned film layer 620 on an adhesive layer surface of the second sub-adhesive layer 613 close to the patterned film layer 620, the deformation of the second sub-adhesive layer 613 is reflected in a lighter degree in the upper layer structure due to the larger thickness of the adhesive layer, which is also advantageous to avoid the problem of module imprints.

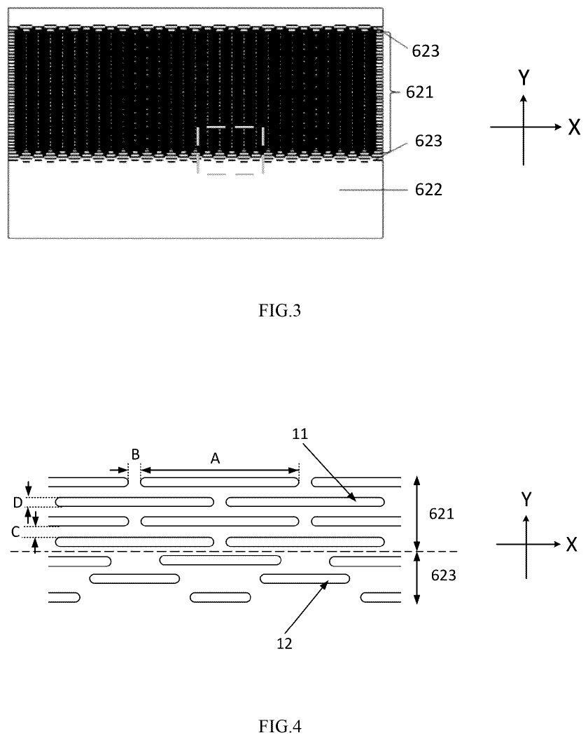

FIG. 3 illustrates a top view of the patterned film layer 620, and FIG. 4 illustrates an enlarged view of a dotted box in FIG. 3. The patterned film layer 620 includes a first area 621 disposed in correspondence with the slidable and rollable area and a second area 622 disposed in correspondence with the planar area. The first area 621 is provided with a plurality of first mesh rows which are extended in a first direction X and disposed parallel to each other in a second direction, and each of the first mesh rows includes at least one first mesh 11 extended in the first direction X. By disposing the first mesh 11, the patterned film layer 620 has the characteristic of being partially rollable. In some embodiments, the preparation material of the patterned film layer 620 may be, for example, stainless steel (SUS), carbon fiber, titanium alloy, etc., and the thickness may be between 100 microns and 300 microns. It is further set that a length A of the first mesh 11 (hereinafter referred to as length A) is between 0.1 and 50 mm (i.e., 0.1 mm≤A≤50 mm); a spacing B between adjacent two of the first meshes 11 in the same first mesh row (hereinafter referred to as mesh spacing B) is between 0.1 mm and 1 mm (i.e., 0.1 mm≤B≤1 mm); a rib width C between adjacent two of the first mesh rows (hereinafter referred to as rib width C) is between 0.1 mm and 3 mm (i.e., 0.1 mm≤C≤3 mm); and a width D of the first mesh (hereinafter referred to as porosity D) is between 0.05 mm and 1 mm (i.e., 0.05 mm≤D≤1 mm).

Further referring to FIGS. 3 and 4, the second area 622 includes a transition area 623, which is adjacent to the first area 621 and is configured to realize a soft-hard transition between the first area 621 and the second area 622, thus improving the overall toughness of the patterned film layer 620. In correspondence with the design of the first mesh 11 in the first area 621, the transition area 623 is provided with a plurality of second mesh rows which are extended in the first direction X and disposed in parallel in the second direction Y, and each of the second mesh rows includes at least one strip-shaped second mesh 12 extended in the first direction X. In this embodiment, it may be defined that the second meshes 12 in a same row have a same lengths A′, the lengths A′ of the second meshes 12 in different rows gradually decreases uniformly in a direction away from the first area 621, and the length A′ of the second mesh in the second mesh row farthest from the first area 621 is between 10% and 100% of the length A of the first mesh, thus realizing a smooth transition between the flexible area and the rigid area, which not only reduces the fracture risk of a soft-hard joint area, but also reduces the problem of module imprints in the soft-hard joint area. To be noted, when the length A′ of the second mesh 12 farthest from the first area 621 is less than 10% of the length A of the first mesh, the transition effect of the second mesh substantially disappears, and it is unnecessary to set the second mesh to be shorter. When the length A′ of the second mesh 12 farthest from the first area 621 is 100% of the length A of the first mesh, it is equivalent to not disposing the transition area. In addition, the mesh spacing B′ between the second meshes 12 in a same row is set depending on the length A′ of the row, so that a sum of A′ and B′ in the row is the same as a sum of the length A and the mesh spacing B in the first area (i.e., A′+B′=A+B). A rib width C′ between adjacent two of the second mesh rows is the same as the rib width C, and a mesh width D′ of the second mesh 12 is also the same as the mesh width D of the first mesh 11.

The support members support the whole display panel, and are respectively a planar support plate 640 corresponding to the planar area, and a plurality of strip-shaped support members 650 corresponding to the slidable and rollable area, wherein the plurality of strip-shaped support members 650 are extended in the first direction and disposed in parallel in the second direction, and the adjacent strip-shaped support members 650 are spaced to realize a bending effect of the display panel in the slidable and rollable area while realizing a support effect when being stretched. FIG. 5 illustrates a top view of the support 600. A width L1 of the strip-shaped support member 650 in the second direction Y (hereinafter referred to as strip width L1) may be mainly between 0.3 mm and 3 mm (i.e., 0.3 mm≤L1≤3 mm), a spacing L2 between the adjacent strip-shaped support members 650 in the second direction Y (hereinafter referred to as spacing L2) is between 0.3 mm and 3 mm (i.e., 0.3 mm≤L2≤3 mm), and the specific sizes of L1 and L2 may be selected according to the overall size of the display panel and the design of the slidable and rollable area, which are not limited in this embodiment. In addition, the planar support plate 640 and the strip-shaped support member 650 have the same thickness and preparation material, for example, stainless steel (SUS), carbon fiber, titanium alloy, etc. may be selected, and the thickness should be limited between 0.1 mm and 1 mm.

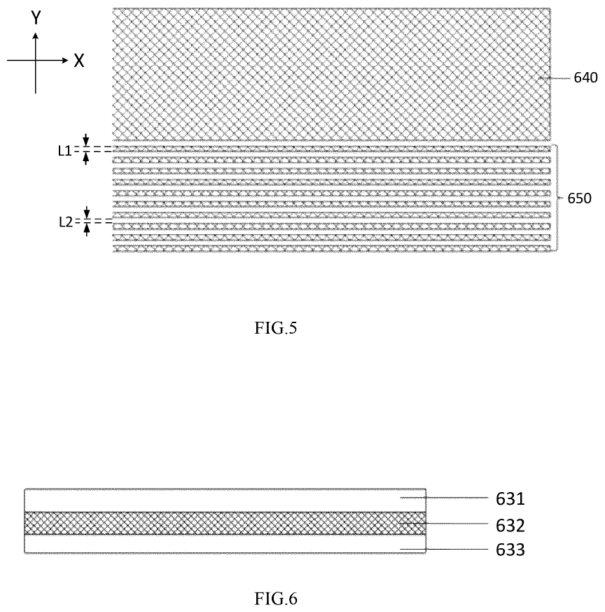

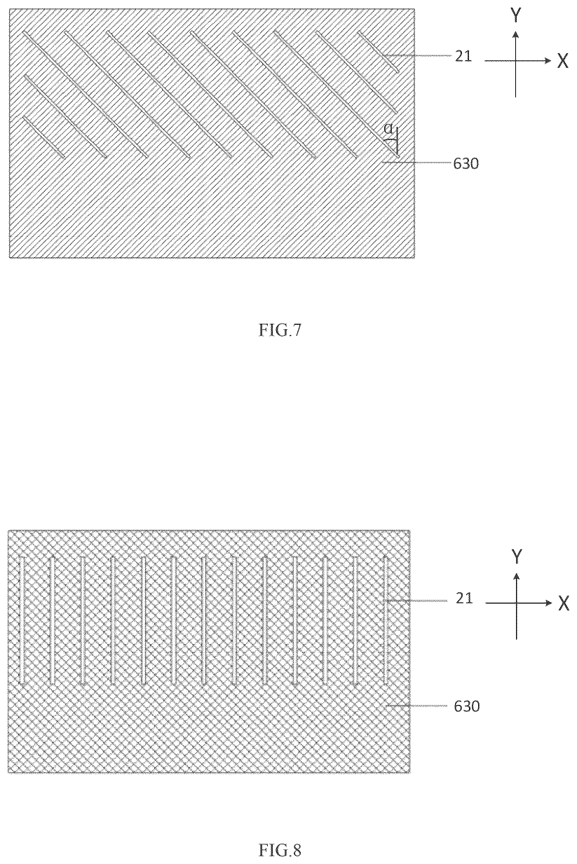

The second adhesive layer 630 bonds the support member and the patterned film layer 620, and the hierarchical structure thereof is shown in FIG. 6, which is similar to that of the first adhesive layer 610, i.e., a third sub-adhesive layer 631, a second base material layer 632 and a fourth sub-adhesive layer 633 are disposed from top to bottom, wherein the third sub-adhesive layer 631 and the fourth sub-adhesive layer 633 are made of an adhesive material such as an acrylic (polymethylmethacrylate) tape or PU glue, with the same or different thicknesses between 25 microns and 100 microns; and the second base material layer 632 made be made of a material such as PET or PU with a thickness between 3 microns and 100 microns. The third area of the second adhesive layer 630 corresponding to the slidable and rollable area is provided with a plurality of first through holes 21 penetrating all the hierarchical structures of the second adhesive layer 630, so that there is an overlap area between an orthographic projection of each of the first meshes 11 on the first plane and an orthographic projection of any one of the first through holes 21 in the third area on the first plane, wherein the third area is a rollable portion in the second adhesive layer 630, and by disposing the first through hole 21, the first mesh 11 in the patterned film layer 620 is open, so that the pressures inside and outside the first mesh 11 are consistent during defoaming, thus avoiding the deformation of the first adhesive layer 610 and the module imprints of the appearance.

When the first through hole 21 is disposed in the second adhesive layer 630, the main design principle is to ensure that each of the first meshes 11 is in an open state, and meanwhile, it is necessary to ensure that the design of the first through hole 21 will not affect the support performance of the support layer located below, especially the strip-shaped support members 650. Therefore, the position and parameter design of the first through hole 21 may be adjusted mainly with reference to the design of the first mesh 11 or the design of the strip-shaped support member 650. FIG. 7 illustrates a first design mode of the first through holes in this embodiment. As shown in FIG. 7, the first through hole 21 may be a strip-shaped through hole extended in a third direction, and an included angle a between the third direction and the second direction in the first plane is between 0 degree and 180 degrees (i.e., 0°≤α≤180°). When the first through hole 21 is disposed, a projection length thereof in the second direction is greater than or equal to a sum of C and D, and less than or equal to a width of the slidable and rollable area in the second direction, i.e., the first through hole 21 may penetrate at least one first mesh in the first mesh row and at most the plurality of first meshes in all of the first mesh rows simultaneously. It should be noted that in FIG. 7, the spacing between adjacent two of the first through holes 21 may be defined according to the actual arrangement of the first meshes 11 and the overall size of the slidable and rollable area, as long as it is ensured that each of the first meshes 11 overlaps one of the first through holes 21 to realize openness.

FIG. 8 illustrates a second design mode of the first through holes in this embodiment. At this time, an included angle between the third direction and the second direction Y is 0 degree or 180 degrees, that is, the third direction coincides with the second direction Y, and the first through holes 21 are extended in the second direction Y, so that the first through holes 21 are vertically disposed in the first direction X. At this time, a length of the first through hole 21 is greater than or equal to the width of the slidable and rollable area in the second direction Y, so that a single first through hole 21 can penetrate all of the first mesh rows; a width P of the first through hole 21 is between 0.1 and A/2 (i.e., 0.1≤P≤A/2), so as to avoid the excessive width from affecting a bonding area between the second adhesive layer 630 and the strip-shaped support member 650; a spacing Q between adjacent two of the first through holes 21 in the first direction X is greater than or equal to 0.5 mm and less than or equal to a sum of A and B (i.e., 0.5≤Q≤A+B) to ensure that each of the first meshes 11 in any one of the first mesh rows overlaps at least one first through hole 21, so as to realize the openness of the first mesh 11.

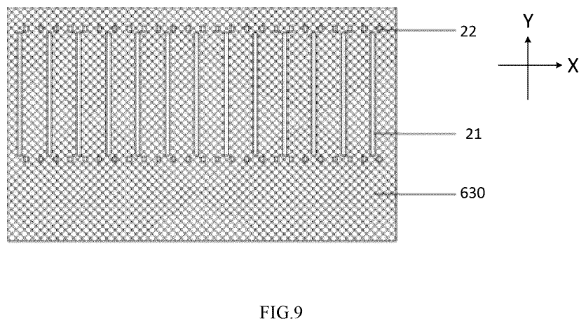

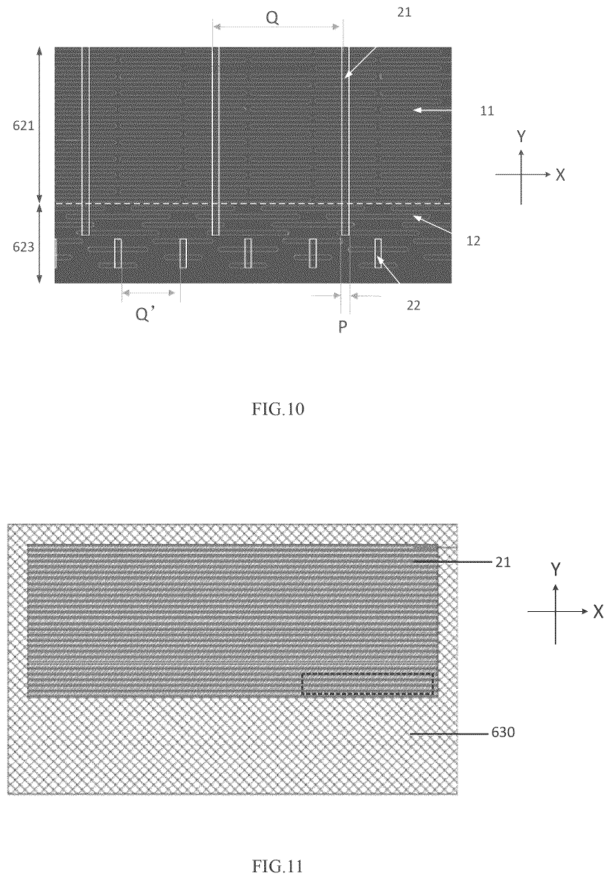

In some embodiments, if the transition area 623 is designed in the patterned film layer 620, a fourth area of the second adhesive layer 630 corresponding to the transition area 623 is provided with a plurality of second through holes 22, as shown in FIG. 9, and being similar to the first through hole 21, the second through hole 22 mainly realizes the openness of the second mesh 12. During implementation, there is an overlap area between an orthographic projection of each of the second meshes 12 on the first plane and an orthographic projection of any one of the second through holes 22 in the fourth area on the first plane. At this time, the length of the first through hole 21 is the same as the width of the slidable and rollable area in the second direction. When the length of the first through hole 21 is greater than the width of the slidable and rollable area in the second direction, the first through hole 21 overlaps the second mesh rows close to the first mesh row, as shown in FIG. 10, and the remaining second meshes 22 in the second mesh row are open based on the second through holes 22.

Further, an extension direction of the second through hole 22 is the same as that of the first through hole 21. Referring to the embodiment shown in FIG. 10, the second through holes 22 are also extended in the second direction Y and disposed in parallel in the first direction X. A sum of the length of a single second through hole 22 and the length of a single first through hole 21 is equal to the width of the slidable and rollable area and the transition area in the second direction Y, a width of the second through hole 22 is between 0.1 and A/2, a spacing Q′ between adjacent two of the second through holes 22 in the first direction X is greater than or equal to 0.5 mm and less than or equal to ½ of the sum of A and B (i.e., 0.5≤Q′≤A+B/2).

To be noted, the arrangements of the first meshes 11 and the second meshes 12 shown in FIG. 10 are only schematic, and correspondingly, the arrangements of the first through holes 21 and the second through holes 22 are only examples in that case. The actual arrangements may be adjusted as long as the first meshes 11 and the second meshes 12 are kept open, which are not limited in this embodiment.

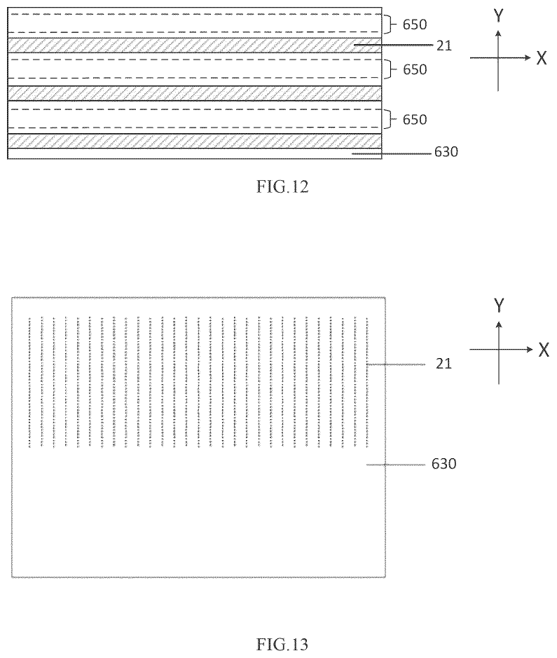

FIG. 11 illustrates a third design mode of the first through holes in this embodiment. At this time, an included angle between the third direction and the second direction Y is 90 degrees, i.e., the third direction coincides with the first direction X. At this time, an extension direction of the first through hole 21 is the same as that of the strip-shaped support member 650. At this time, a bonding area of the strip-shaped support member 650 should be considered during the design of the first through hole, so the size design of the first through hole 21 is related to the parameters of the strip-shaped support member 650. Specifically, FIG. 12 illustrates an enlarged view of a dotted block in FIG. 11, in which a shaded portion represents the disposed first through hole 21, a width of which is greater than or equal to L2/2 and less than or equal to L2 (i.e., L2/2≤the width of the first through hole≤L2), the spacing between adjacent two of the first through holes 21 in the second direction Y is greater than or equal to L1 and less than or equal to a sum of L1 and L2 (i.e., L1≤the spacing between the first through holes≤L1+L2) to ensure that the first through holes 21 are disposed between adjacent strip-shaped support members 650 (indicated by dotted lines in FIG. 12) as far as possible, thus ensuring the adhesive layer bonding with the first through holes 21 above the strip-shaped support members 650, so that the strip-shaped support members 650 are stabilized; and the length of the first through hole 21 is only required to be greater than a difference between a width of the patterned film layer 620 in the first direction and A. In this case, the strip-shaped support member 650 has a largest bonding area. Even though a small number of the first meshes 11 may not be open, the effect of synchronizing the internal and external environments of the mesh can be achieved due to a small bonding area of the adhesive layer at the edge of the mesh in an area corresponding to the second adhesive layer 630. To be noted, the strip-shaped support member 650 marked by the dotted line in FIG. 12 is only used to illustrate the position of the strip-shaped support member 650 fixed on the second adhesive layer.

FIG. 13 illustrates a fourth design mode of the first through holes in this embodiment. At this time, the number of the first through holes 21 is the same as that of the first meshes 11, and they are disposed in one-to-one correspondence, i.e., an orthographic projection of each of the first through holes 21 on the first plane is within an orthographic projection of the corresponding first mesh 11 on the first plane. That is, the openness of the first meshes 11 is realized by disposing the dot-like first through holes 21 corresponding to the positions of the first meshes 11, and at this time, the bonding area can be ensured to a maximum extent, so that the bonding of the strip-shaped support member 650 can be more stable. Specifically, a width of the first through hole 21 in the first direction X is greater than or equal to 0.1 mm and less than or equal to A (i.e., 0.1≤the width of the first through hole 21 in the first direction X≤A), and a spacing between adjacent two of the first through holes 21 in the first direction X is greater than or equal to 0.5 mm and less than or equal to a sum of A and B (i.e., 0.5≤ the spacing between the first through holes in the first direction X≤A+B); a width of the first through hole 21 in the second direction Y is greater than or equal to 0.1 mm and less than or equal to D (i.e., 0.1≤the width of the first through hole in the second direction Y≤D), and a spacing between adjacent two of the first through holes 21 in the second direction Y is less than twice a sum of C and D (i.e., D≤the spacing between the first through holes in the second direction Y≤2*(C+D)).

Further, when the patterned film layer 620 is provided with the transition area 623, the second through holes 22 may also be designed at the corresponding position of the second mesh 12 in the way shown in FIG. 12, and the corresponding position and parameters may be designed according to the size of the second mesh 12, which will not be described in detail in this embodiment.

To be understood, in the actual preparation of the second adhesive layer 630, the third sub-adhesive layer 631 and the fourth sub-adhesive layer 633 may be prepared respectively on an upper surface and a lower surface of a complete second base material layer 632 before the first through holes 21 are disposed, or the first through holes 21 may be disposed on the second base material layer 632 before the third sub-adhesive layer 631 and the fourth sub-adhesive layer 633 are prepared, which is not specifically limited in this embodiment, and may be flexibly adjusted according to the conditions such as the operating device and the preparation process during the actual implementation.

In addition, the several designs of the first through holes or the second through holes according to this embodiment are mainly realized based on the strip-shaped through holes. In the actual design of the shape of a through hole, an X-shaped, S-shaped or even W-shaped through hole may be formed based on the strip-shaped through hole, as long as the openness of the mesh is ensured.

In this embodiment, by disposing the first through holes in the second adhesive layer, each of the first meshes in the patterned film layer can be open through one of the first through holes, so that the internal and external pressures of the first mesh can be consistent during defoaming, thus avoiding the deformation of the adhesive layers on both sides thereof (especially the first adhesive layer) towards the mesh, and the problem of module imprints will not be caused.

A second embodiment of the present disclosure provides an electronic device, which may be a device with a display function, such as a mobile phone, a tablet computer, a smart watch or the like. The above device at least includes the slidable and rollable display panel according to the first embodiment of the present disclosure, so as to facilitate a user to expand the screen during the use of the device and achieve a better display effect. In the display panel used for the electronic device in this embodiment, the first through holes are disposed in the second adhesive layer during preparation, so that each of the first meshes in the patterned film layer can be open through one of the first through holes, and the internal and external pressures of the first mesh can be consistent during defoaming, thus avoiding the deformation of the adhesive layers on both sides thereof (especially the first adhesive layer) towards the mesh, and the problem of module imprints will not be caused.

A number of embodiments of the present disclosure have been described in detail above, but the present disclosure is not limited to these specific embodiments. Based on the concept of the present disclosure, persons skilled in the art can make many variations and modifications, which should fall within the protection scope of the present disclosure.

1. A slidable and rollable display panel, comprising a planar area and a slidable and rollable area, the display panel comprising a protective cover plate, and a surface on a side of the protective cover plate being provided with an optical adhesive layer, a polarizer, a touch function layer, a display function layer, a back film and a support layer which are sequentially disposed in a direction opposite to a light-emitting direction of the display panel; and the support layer at least comprising a first adhesive layer, a patterned film layer, a second adhesive layer and a support member which are sequentially disposed from top to bottom; wherein
a first area of the patterned film layer corresponding to the slidable and rollable area is provided with a plurality of first mesh rows which are extended in a first direction and disposed in parallel in a second direction, and each of the first mesh rows comprises at least one first mesh extended in the first direction, which is perpendicular to the second direction in a first plane, the first direction being an extension direction of a boundary line between the planar area and the slidable and rollable area, and the first plane being a plane where the planar area is located; and
a third area of the second adhesive layer corresponding to the slidable and rollable area is provided with a plurality of first through holes, and there is an overlap area between an orthographic projection of each of the first meshes on the first plane and an orthographic projection of any one of the first through holes in the third area on the first plane.

2. The display panel according to claim 1, wherein a length A of the first mesh is between 0.1 mm and 50 mm; and a spacing B between adjacent two of the first meshes in the same first mesh row is between 0.1 mm and 1 mm.

3. The display panel according to claim 2, wherein a rib width c between adjacent two of the first mesh rows is between 0.1 mm and 3 mm; and a width D of the first mesh is between 0.05 mm and 1 mm.

4. The display panel according to claim 3, wherein the first through hole is a strip-shaped through hole extended in a third direction, an included angle between the third direction and the second direction in the first plane is between 0 degree and 180 degrees, and a projection length of the first through hole in the second direction is greater than or equal to a sum of C and D and less than or equal to a width of the slidable and rollable area in the second direction.

5. The display panel according to claim 4, wherein in a case where the included angle is 0 degree or 180 degrees, the plurality of first through holes are extended in the second direction and disposed in parallel in the first direction, a length of the first through hole is greater than or equal to the width of the slidable and rollable area in the second direction, a width of the first through hole is between 0.1 and A/2, and a spacing between adjacent two of the first through holes in the first direction is greater than or equal to 0.5 mm and less than or equal to a sum of A and B.

6. The display panel according to claim 5, wherein a second area of the patterned film layer corresponding to the planar area comprises a transition area that is adjacent to the first area and provided with a plurality of second mesh rows, which are extended in the first direction and disposed in parallel in the second direction, each of the second mesh rows comprises at least one second mesh extended in the first direction, lengths of the second meshes in different rows decrease uniformly in turn in a direction away from the first area, and a length of the second mesh in the second mesh row farthest from the first area is between 10% and 100% of the length A of the first mesh.

7. The display panel according to claim 6, wherein a fourth area of the second adhesive layer corresponding to the transition area is provided with a plurality of second through holes, and there is an overlap area between an orthographic projection of each of the second meshes on the first plane and an orthographic projection of any one of the second through holes in the fourth area on the first plane, or, there is an overlap area between orthographic projections of a part of the second meshes on the first plane and an orthographic projection of any one of the first through holes on the first plane, and there is an overlap area between orthographic projections of the other part of the second meshes on the first plane and an orthographic projection of any one of the second through holes on the first plane.

8. The display panel according to claim 6, wherein an extension direction of the second through hole is the same as that of the first through hole, the plurality of the second through holes are disposed in parallel in the first direction, and a sum of a length of the second through hole and the length of the first through hole is equal to the width of the slidable and rollable area and the transition area in the second direction, a width of the second through hole is between 0.1 and A/2, and a spacing between adjacent two of the second through holes in the first direction is greater than or equal to 0.5 mm and less than or equal to ½ of the sum of A and B.

9. The display panel according to claim 4, wherein an area of the support member corresponding to the planar area is provided with a planar support plate, and an area of the support member corresponding to the slidable and rollable area is provided with a plurality of strip-shaped support members, which are extended in the first direction and disposed in parallel in the second direction, a width L1 of the strip-shaped support member in the second direction is between 0.3 mm and 3 mm, a spacing L2 between the adjacent strip-shaped support members in the second direction is between 0.3 mm and 3 mm, and a thickness of the strip-shaped support member is the same as that of the planar support plate;
in a case where the included angle is 90 degrees, the plurality of first through holes are extended in the first direction and disposed in parallel in the second direction, a length of the first through hole is greater than a difference between a width of the patterned film layer in the first direction and A, a width of the first through hole is greater than or equal to L2/2 and less than or equal to L2, and a spacing between adjacent two of the first through holes in the second direction is greater than or equal to L1 and less than or equal to a sum of L1 and L2.

10. The display panel according to claim 3, wherein the first through holes are disposed corresponding to the first meshes, and an orthographic projection of each of the first through holes on the first plane is within an orthographic projection of the corresponding first mesh on the first plane;
a width of the first through hole in the first direction is greater than or equal to 0.1 mm and less than or equal to A, and a spacing between adjacent two of the first through holes in the first direction is greater than or equal to 0.5 mm and less than or equal to a sum of A and B; a width of the first through hole in the second direction is greater than or equal to 0.1 mm and less than or equal to D, and a spacing between adjacent two of the first through holes in the second direction is less than twice a sum of C and D.

11. The display panel according to claim 1, wherein the first adhesive layer comprises a first sub-adhesive layer, a first base material layer and a second sub-adhesive layer which are sequentially disposed from top to bottom, and a thickness of the second sub-adhesive layer is between 25 microns and 100 microns.

12. An electronic device, at least comprising the slidable and rollable display panel according to claim 1.
